(19) United States
(12) Patent Application Publication
(10) Pub. No.: US 2003/0069043 A1
(43) Pub. Date: Apr. 10, 2003

(54) Methods and devices for wirelessly transmitting data in dependence on location

(76) Inventors: Pallav Chhaochharia, Singapore (SG); Hari Krishna Garg, Singapore (SG); Kok Wee Kenneth Ong, Singapore (SG)

Correspondence Address: Kilworth, Gottman, Hagan & Schaeff, L.L.P., Suite 500, One Dayton Centre, Dayton, OH, 45402-2023, US

(21) Appl. No.: 10/177,741

(22) Filed: Jun. 21, 2002

Related U.S. Application Data
(60) Provisional application No. 60/328,266, filed on Oct. 10, 2001.

(51) Int. Cl. H04M 1/00

(52) U.S. Cl. 455/561

(57) ABSTRACT

A method and devices for wirelessly transmitting data are disclosed. Data is transmitted between to mobile devices in dependence on the location of the device. In one embodiment, one or more of the power level of transmission; direction of transmission; encryption; and coding scheme may be controlled at a base station in dependence on the location of the mobile device. Multiple base stations may transmit to a single device. The base station may include one or more directional transmission elements. Location information may similarly be used to control the overall operation of a wireless network. Channel selection, hand-offs and base station selections for communication with a mobile device may all be effected in dependence on information about the location of a recipient mobile device.

### CROSS-REFERENCE TO RELATED APPLICATIONS

This application claims benefits from U.S. Provisional Patent Application No. 60/328,266 filed Oct. 10, 2001, the contents of which are hereby incorporated herein by reference.

### FIELD OF THE INVENTION

The present invention relates generally to wireless communications and more particularly to transmission of signals in wireless networks in dependence on location of mobile devices.

### BACKGROUND OF THE INVENTION

Transmission of signals in a wireless environment, such as a cellular radio or telephone network, is usually between a base station and a mobile device. An allocated portion of the radio-frequency (RF) spectrum is shared between the base station and multiple devices. Multiple data channels are multiplexed together within this frequency range.

Because the available RF frequency range is limited, cellular networks further geographically divide the network into cells. Base stations broadcast on channels in the allocated frequency range within the cell. Each base station does not broadcast beyond cell boundaries. Moreover, adjacent cells typically use different available channels in the allocated RF spectrum. As such, communications in adjacent cells do not typically interfere. Accordingly, the allocated portion of the RF spectrum may be re-used in multiple appropriately spaced cells, allowing each base station to independently communicate with a plurality of different mobile devices increasing the number of subscribers that may be served. In order to provide wireless communications to multiple subscribers, each mobile device is typically only allocated a single channel.

The bandwidth of each channel is further limited by channel noise, distortion, scattering and fading, resulting in degradation in the signal quality at the receiver. This affects data detection at the receiver. Error in data detection at the receiver affects the quality-of-service (QoS), and further limits the data transfer rate between the base station and mobile station.

As will be appreciated from the above, the total capacity of a base station to communicate with multiple mobile devices is limited by the bandwidth of the allocated portion of the frequency spectrum; the modulation techniques; and the number of mobile devices within the base station's cell.

Thus, with limited spectral bandwidth, only services that require low data transfer rates with high bit error rates and acceptable delay, such as voice communications, are feasible and practically possible.

Accordingly, methods and devices facilitating increased data transfer in a wireless network are desirable.

### SUMMARY OF THE INVENTION

In accordance with the present invention, knowledge of the location of mobile device is used to optimize mobile device, base-station and overall network performance. Optionally, knowledge of present and/or past locations may be used to predictively control network performance.

Knowledge of the location of a mobile device may be used to control which of a plurality of base stations communicate with the device; at what power levels; and using what type of coding, modulation and security techniques. Advantageously, base stations may additionally transmit data to the mobile device directionally. As a result, overall network capacity may be improved. The bandwidth of communication with each mobile device may be increased, and the error rate in data received by the mobile devices may be reduced.

In accordance with one aspect of the present invention, knowledge of the location of a mobile device is used to control directional data transmission from another transmitter within the network. Exemplary of the invention, data can be directionally transmitted, typically with narrow angular dispersion. Hence, the mobile device can be allotted a channel in an allotted frequency range that is concurrently being used by another mobile device in another part of the network. This increases a base station's effective capacity. The increased capacity may be used to assign multiple channels to a single mobile device, providing higher bandwidth communication with the mobile device.

Advantageously, multiple base stations may directionally transmit into a single cell of the wireless network without interfering. Unused capacity of one base station may thus be used to communicate with devices in an adjacent cell. Moreover, data may be transmitted to a single mobile device from several base stations.

In accordance with another aspect of the present invention, location information may be used to control network management. Use of location information may be used to track movement of mobile devices and predict future mobile device location, and therefore call hand-offs within a cellular network. The allocation of channels to mobile devices in a cell may be done based on the current location and predicted future location of the mobile devices that are using the re-used channels in other cells so as to minimize co-channel interference. Transmission power levels of both base stations and mobile devices may be controlled based on the location and channel conditions to minimize interference. Similarly, different coding, modulation and security schemes may be used based on the user's location and channel conditions. This may improve network performance.

In accordance with a further aspect of the present invention, there is provided a method of operating a base station in a cellular communications network. The base station includes at least one directional transmission element. The method includes receiving an indication of a location of a mobile device in communication with the base station over the communications network; predictively controlling the directional transmission element to direct transmission from the base station to the mobile device based on the indication, and past indications of location of the mobile device received from the mobile device.

In accordance with yet a further aspect of the present invention, there is provided a method of communication with a mobile device including at each of a plurality of base stations in wireless communications with the mobile device; receiving an indication of a location of the mobile device over the wireless communications network; transmitting from several of the plurality of base stations to the mobile device based on the location.

In accordance with another aspect of the present invention, there is provided a base station for use in a wireless communication network, including an interface to receive an indication of a location of a mobile device; a transmitter; a controller in communication with the transmitter operable to control transmission of the transmitter to control one or more of a direction, coding, modulation, encryption of transmission of the data in dependence on the indication.

In accordance with a further aspect of the present invention, there is provided a mobile communications device including a plurality of receivers, each for receiving one of a plurality of signals from a different base station in a wireless network; a data combiner in communication with the receivers, for combining the plurality of signals.

In accordance with yet a further aspect of the present invention, there is provided a method of operating a base station in a wireless network, including receiving an indication of a location of a mobile device in communication with the base station over the communications network; transmitting data from the base station to the mobile device based on the location, by controlling one or more of a power level, direction, and coding of transmission of the data in dependence on the indication.

In accordance with another aspect of the present invention, there is provided a wireless communications network including a plurality of wireless base stations in communication with each other and with a mobile device. Each of the wireless base stations includes an interface to receive an indicator of a location of the mobile device on the network, and a transmitter operable to transmit data to the mobile device in a manner dependant on the location.

In accordance with a further aspect of the present invention, there is provided a method of operating a base station in a wireless network, including receiving an indication of a location of a mobile device in communication with the base station over the communications network; choosing an available transmission channel to transmit data to the mobile device, based on the location, so as to minimize interference with communications to other mobile devices; transmitting data from the base station to the mobile device based over the chosen channel.

In accordance with yet a further aspect of the present invention, there is provided a method of operating a wireless network, in which a mobile device is in communication with a proximate base station including receiving indicators of a location of a mobile device on the network; predictively coordinating hand-offs between base stations in dependence on the indicators.

In accordance with another aspect of the present invention, there is provided a method of operating base stations on first and second of wireless networks, including receiving indicators of a location of a mobile device on the first and second network; predictively coordinating hand-offs between base stations on the two networks in dependence on the indicators, as the mobile device moves from a location in proximity with a base station on the first network into proximity with the a base station on the second network, allowing communication with the mobile device to be handed-off from the first network to the second network.

In accordance with a further aspect of the present invention, there is provided a method of operating a mobile device capable of wireless transmission, including receiving an indication of a location of a recipient device in wireless communication with the mobile device; transmitting data from the mobile device to the recipient device based on the location, by controlling one or more of a power level, direction, and coding of transmission of the data in dependence on the indication.

In accordance with yet a further aspect of the present invention, there is provided a switching center in a mobile communications network, in communication with a plurality of base stations within the network, and operable to control concurrent transmission of data from the plurality of base stations to a particular mobile device in dependence on a location of the particular mobile device.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of this invention,

FIG. 1 illustrates a conventional wireless cellular communications network;

FIG. 2 illustrates a network including multiple base stations, each operable to transmit devices in dependence of the positions of wireless devices, exemplary of an embodiment of the present invention;

FIG. 3 illustrates a master switching center used in the network of FIG. 2;

FIGS. 4 and 5 schematically illustrate multiple base stations of FIG. 2 transmitting to a single wireless device;

FIG. 6 schematically illustrates a single wireless device of FIG. 3 transmitting to multiple base stations on a reverse link;

FIG. 7 illustrates a base station including a directional element within a single cell, exemplary of an embodiment of the present invention; and

FIG. 8 illustrates mobile receivers in communication with terrestrial and satellite base stations, in manners exemplary of the present invention.

### DETAILED DESCRIPTION

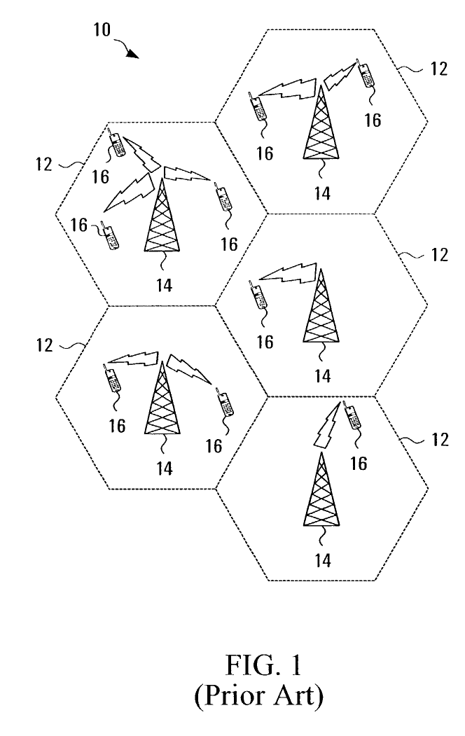

FIG. 1 illustrates a conventional wireless cellular communications network 10. As illustrated, a geographic area serviced by network 10 is divided into a plurality of cells 12. Within each cell 12, a base station 14 broadcasts to all mobile devices 16 within that cell over the same allocated range of the RF spectrum. Mobile devices 16 may be conventional handheld cellular phones, cellular radios, fixed wireless stations or the like. Mobile devices and base stations 14 may comply with any one of a number of known cellular networking protocols, including the GSM, TDMA, CDMA, or similar protocols.

The broadcast from base station 14 carries multiple communications channels multiplexed using any one of a number of known multiplexing techniques. Known multiplexing techniques include time-division multiplexing (TDMA); frequency division multiplexing (FDMA); orthogonal frequency division multiplexing (OFDM), code division multiplexing (CDMA) and the like. Each base station 14 communicates with a mobile device 16 in its cell over a single one of these multiple channels. To increase the number of mobile stations 14 that may be served on the network 10, each base station 14 only communicates with mobile devices 16 within its cell. As a mobile device 16 travels from one cell to an adjacent cell, communication with a serving base stations 14 is handed off to the base station in the adjacent cell. In this way, the allocated RF spectrum may be re-used from cell to cell and the same network channel may be used by multiple mobile devices in different cells. Channels within any one cell may be reused as mobile devices 16 using those channels leave the cell for another. In order to limit interference between mobile devices wireless channels are not re-used in adjacent cells. Instead, wireless channels may be re-used in cells a defined distance from each other. For example, conventional GSM protocols specify that wireless channels are only re-used every three, seven, twelve or similarly spaced cells. Base-stations within adjacent cells, however, may be capable of transmitting on channels used by adjacent cells.

As noted, within each cell 12, each mobile device 16 typically only receives data from the serving base station 14 using a single data channel in the available frequency range. Of course, mobile devices 16 communicate with base stations 14 in neighboring cells on control channels for call hand-offs and other network management procedures. Communication over a single data channel, however, limits the available bandwidth between base station 14 and the mobile devices 16.

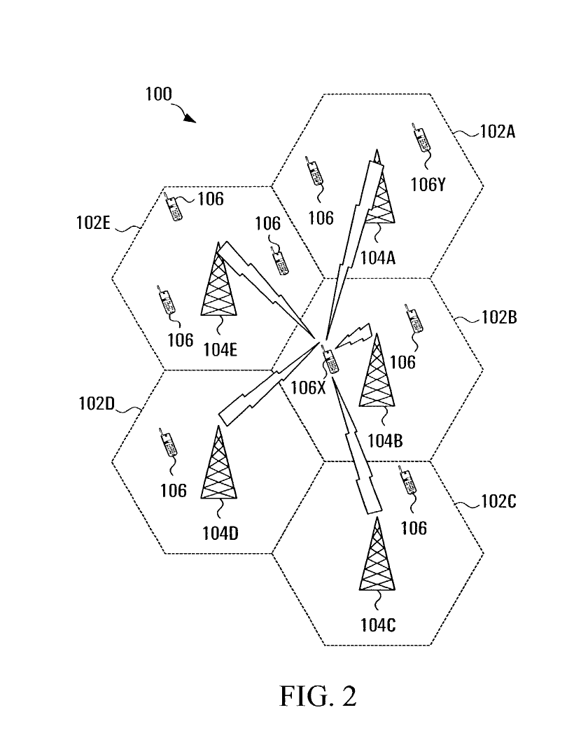

Now, FIG. 2 illustrates a wireless network 100, exemplary of an embodiment of the present invention. Network 100 is divided into a plurality of convention cells 102a-102e (collectively cells 102). Each cell includes a base station 104a-104e (collectively and individually base station(s) 104) exemplary of an embodiment of the present invention.

Base stations 104 may further be in communication with each other over a signalling network. Each base station is capable of communicating with one or more mobile devices using an appropriate wireless data transfer protocol. Base stations 104, like base stations 24 (FIG. 1), may communicate using conventional GSM, CDMA, TDMA or similar protocols. Base stations 104, however, may communicate with mobile devices in dependence on the location of such devices, as detailed herein.

A plurality of mobile devices 106 and 106x (collectively devices 106) each substantially identical to mobile device 16 (FIG. 1) are also illustrated. Mobile devices 106, unlike devices 16 are preferably adapted to provide a signal indicative of their location to one or more of base stations 104. That is, mobile device 106, provide base station 104 with information of the location (or an estimate of the location) of that particular mobile device. Optionally, mobile device 106 could be replaced with a device that does not provide such a signal and may be identical to device 16. The location of a mobile device 106 may be ascertained at the base station in any number of ways, depending on the information provided by the mobile device 106. Conventional location determination procedures including for example, triangulation-based techniques, GPS, Angle-of-Arrival, Time-of-Arrival, and Time-Difference-of-Arrival, with varying accuracy and robustness. This location indication may be determined at the mobile device or anywhere else on the network.

An indication of the location may be provided to base station 104 in any number of ways. Location information may, for example, be provided by the mobile device 106 over a control channel, automatically through the network. This location may be ascertained, for example, by way of a location receiver forming part of device 106, as detailed below. Alternatively, the location of the device could be ascertained by a user of a mobile device 106 and that user may inform the network of the location of the mobile device. Thus, a user of a mobile device may key in his location information to the system based on results from his GPS receiver, or simply based on knowledge of the location.

The precision of the location information provided to base station 104 may affect how it is used by base stations 104 as detailed below. Additionally, location information may be updated periodically as the location of mobile device 106 changes. Again, changes in location may be ascertained at device 106 and provided to a base station 104.

The location of the mobile device 106 may be calculated in any arbitrary coordinate system. Hence, the output may be latitudinal and longitudinal coordinates or Cartesian with an arbitrarily chosen reference origin or any other.

Other ways by which the location of mobile device 106 may be determined and base station 104 may be informed of this location will be readily understood by a person of ordinary skill.

Once the location information for mobile device 106 is know at any particular base station 104, this knowledge may be shared as required across base stations 104, within the network, using the signalling network (not show) accessible to base stations 104.

Now, location information of mobile device 106 known at base stations 104 may be used to control transmission of data from base stations to mobile device 106 in order to improve network performance in many ways. For example, which one or more of multiple base stations 104 is to communicate with a mobile device; using which channels; at what power levels; and what coding and/or modulation techniques may be adapted in dependence on the location of the mobile device. With this knowledge of mobile device location, the transmission to each mobile device may be controlled at the network to optimize signal at the mobile device and minimize interference with other mobile devices. In this way, conventional cell boundaries need not necessarily be respected, and base stations may transmit across boundaries.

So, for example, as illustrated in FIG. 2 multiple base stations 104a, 104b, 104c, 104d and 104e may concurrently transmit data to mobile device 106x. The nature of the transmission from each base station may be controlled in dependence on the location of device 106x and the nature of the data to be transmitted to the device 106x.

For example, multiple base stations 104 may communicate with a mobile device 106x, over the same channel to improve the signal quality (i.e. signal to noise ratio) at a single receiver of the mobile device. As will be appreciated, improved signal quality may allow for higher band width transmission, and may significantly reduce the need for data retransmission to correct errors. This, in turn, increases overall data throughput.

The knowledge of the device's location may be used to transmit from several of the devices. For example, knowledge of the locations may be used to select which of base stations 104 should transmit and to control the power level used by each transmitter at the multiple base stations 104 to provide the downlink channel to the mobile device. Multiple arriving signals at the device may constructively interfere increasing the overall power of the signal received at device 106x. Data destined for a mobile station 106x may be shared among base station using a wired network coupling the base stations. Each base station may transmit the same data on the same channel.

Conveniently, data may be transmitted across conventional cell boundaries by one or more of the base stations 104. Optionally, the power output of each base station 104 may be limited so that signals from one base station do not cross multiple cell boundaries. For example, power may be limited so that signals are not transmit into adjacent cells, thereby avoiding unnecessary interference with corresponding reused channels in other cells.

Alternatively or additionally, location dependent coding schemes may be used so that a primary one of base stations 104 in communication with the device may provide data to the device, while one or more of the remaining base stations 104 may transmit redundant data over the same channel that may be used at the device to improve the overall quality of the received data. For example, space time coding may be used so that a primary base station provides data to be received by mobile station 106x, while other base stations provide redundant forward error correcting data over the same channel that may be used at device 106x to compensate for errors in data from the primary base station. That is, with the location of mobile device 106x known or determined, the transmitted signals from the multiple base stations 104 may be specially encoded using techniques such as space-time coding to provide antenna diversity effects (constructive interference being one such effect) at the receiver of the mobile device 106x, as for example disclosed in U.S. Pat. Nos. 6,115,427 and 5,479,448. Device 106x of course, may be adapted to receive the data from multiple base stations and assemble data to minimize errors. As device 106x moves within network 100, which of base stations 104 acts as a primary transmitter, and which transmitters transmit redundant data may vary in dependence on the location of device 106x.

Alternatively or additionally, mobile device 106x may include one receiver or multiple receivers to independently receive signals from the multiple base stations 104, and assemble these. In this way, the bandwidth to a mobile device 106x is shared among multiple base stations. Additional bandwidth may be used for increased forward error correction transmitted over the multiple channels from multiple base stations, or simply to increase the bandwidth of data provided to the mobile device.

Further, channel selection from each base station may be based on the location of mobile device 106x and chosen so as to minimize the interference between the other channels used on network 100. Thus, in the case of allocating a data channel to a mobile device outside a traditional cell of a particular base station this base station may allocate the mobile device 106x a channel that reduces and potentially minimizes interfere with other channels used by the mobile device 106x or other mobile devices.

As a further addition or alternative, downlink data from network 100 may be split and transmitted by multiple base stations, over one or more channels. In this way, interception of an entire data message requires receipt of signals originating with multiple base stations. Interception of data by a third party is thus made more difficult, enhancing network security. The split message may be transmit over multiple independent channels, or over a single channel. Optionally, signals transmit from one or more base stations may be encrypted to further enhance security. Mobile device 106x may, in turn include a suitable data combiner to combine the split data, and decrypt any portions as necessary.

Additionally, by transmitting across conventional cell boundaries, the likelihood of call blocking to a device in a particular cell may be reduced in network 100. That is, if the location of the mobile device 106x is known or estimated, and is communicated across cells 102, base stations 104 in neighbouring cells may independently transmit to a mobile device on available channels for those base stations. This increases the capacity available for a single mobile device within a cell, as available channel resources may be allocated to mobile devices in neighbouring cells.

So, in the event insufficient transmitters are available in one cell, capable transmitters in adjacent cells could suitably communicate with the mobile device in the adjacent cell on additional channels. To avoid possible interference with mobile stations in other cells, transmissions by base stations across cell boundaries may optionally be limited to specific regions of immediately adjacent cells. Effectively then, transmission from base stations to mobile devices becomes flexible. Each base station's coverage varies in dependence on the availability of other base stations and channels and the location of mobile devices.

Additionally, use of location information may be used to handle conventional call hand-offs between base stations in a more effective manner. Advantageously, channels may be allocated predictively from base station to base station as the mobile device 106x moves. Location and changes in location communicated from device 106x to base stations 104 may be used to predict call hand-offs as device 106x moves closer and farther from individual base stations. In this way, for example, a channel for a moving device may be reserved in advance, with a reserved channel preventing excess allocation of channels for new calls at a base station. This may reduce the likelihood an existing call is dropped, as a mobile device moves within network 100.

Location information may be stored. As such, historical indicators of the location of device 106x may be used to control network 100 predictively, using past and possibly present indicators of device location. The prediction of the future locations of the mobile could also include use of the previous location data of the user along with the user's past history of visiting certain locations in conjunction with a Geographic Information System (GIS) to track the route the user might take. Alternatively, the user might inform the service provider where he or she is going and the route that he or she will take either which may be automatically done through systems (for example, navigation systems that map the route his car takes, etc) that he or she is using in the course of the journey or might be dictated verbally.

Again, optionally channels that are reserved predictively could be chosen and reserved so as to minimize interference with channels already in use.

Although, relatively precise knowledge of the location of the mobile device 106x is preferred, it is not necessary. For example, even if the location of the mobile device 106x is not precisely known, the conventional received signal strength indicator (RSSI) in the mobile device may continuously monitor the signal strengths from neighbouring base stations on a control channel to estimate location of the device 106x. The RSSI can thus be used to determine which base stations are nearest to the mobile terminal and hence maintain communication with those base stations. Thus, for example, if the RSSI indicates that the strongest signals received are from the base stations 104a and 104e, these base stations 104a and 104e may be used to provide transmission channels to the mobile device 106x, hence enhancing the data capabilities of the user. The RSSI may also be used to refine the process of location determination by giving a rough estimate of the area where the mobile terminal is located.

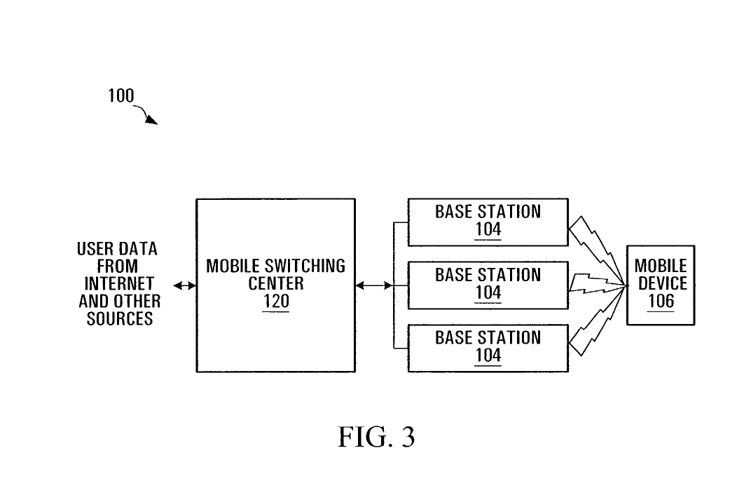

FIG. 3 schematically illustrates a mobile switching center 120 in communication with base stations 104. Switching center 120 is part of, and controls overall operation of network 100, in manners exemplary of the present invention. Switching center 120 and may be in communication with base stations 104 using a data and control network [not shown]. Switching center 120 under software control may centrally collect the locations of multiple mobile devices 106 on network 100. Moreover, this central switching center 120 may provide up link data from another land linked network to base stations 104 for ultimate provision to mobile devices 106, as described above. Switching center 120 may thus split data to be provided to a device, and provide portions to individual base stations 104 or multicast data to base stations 104. Moreover, switching center 120 may control which available base station(s) communicate with any mobile device, over which channels.

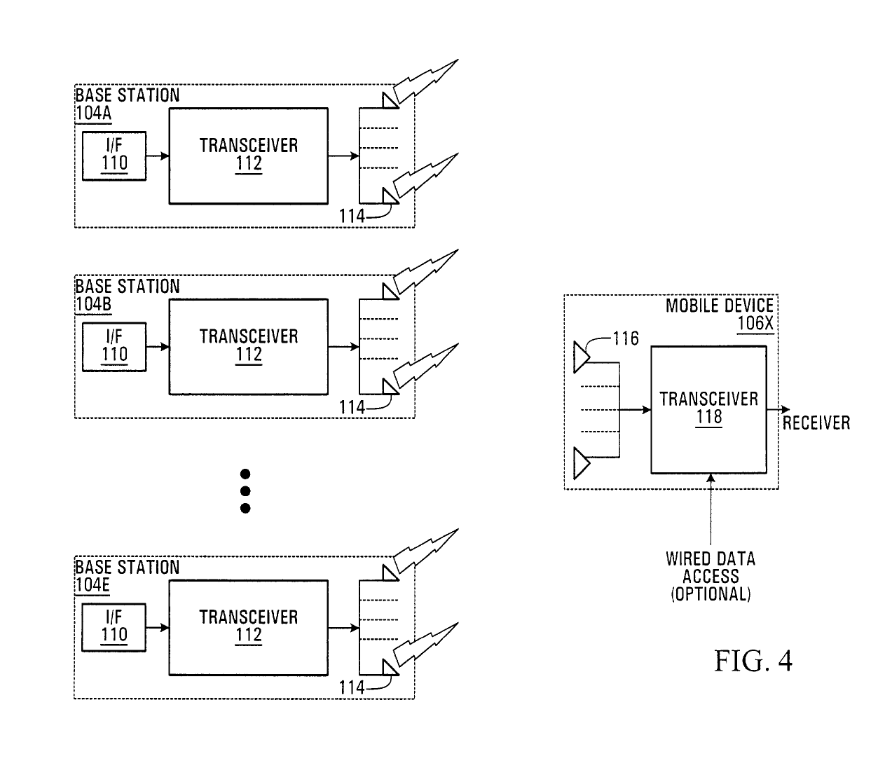

FIG. 4 schematically illustrates the transmission of a single data signal from multiple base stations 104 of FIG. 2. As illustrated, each base station 104 preferably includes an interface 110 coupling the base station to one or more wired networks for receipt and provision of data and control information (as for example from switching center 120). Each base station 104 further includes a wireless transceiver 112. Transceiver 112 includes a receiver for receipt of data transmitted wirelessly by mobile stations. Similarly, transceiver 112 includes a transmitter that may transmit at variable power, and using multiple coding schemes as detailed above. This transmitter further includes or is in communication with a controller to control its transmission in dependence of location information. Transmitter and receivers include suitable modulators and demodulators to format and modulate and demodulate data into using a suitable modulation technique. For example transceiver 112 may be able to code using phase-shift keying (PSK) based modulation techniques, using an 8 or higher PSK signalling mode instead of the typical 4-PSK mode if location of the user is near as there would be low interference along signal path. This would effectively increase the data rate for the same error rate in signal transmission. Transceiver 112 is in turn coupled to one or more transmission elements 114 used to broadcast suitably modulated data over RF channels.

Mobile device 106x includes at least one antenna 116 for receipt and transmission of data using the wireless network. The antenna 116 is in communication with a transceiver 118. Transceiver 118 may include a modulator/demodulator, encoder/decoder and a data combiner.

Mobile device 106x may optionally include a location receiver or any other suitable component for aiding in location determination of the mobile device that is in communication with or part of transceiver 118. As will be appreciated the location receiver may be a GPS receiver may receive location information from global positioning satellites that may be provided by device 106x to base stations 104.

FIG. 4 further illustrates how a single signal may be divided into multiple data portions. Each one of these data portions may be transmitted by one of the multiple base stations 104a-104e for receipt by a single mobile device. Each may be received by a single receiver at mobile device 106x. For example, data destined for a mobile device may be split between various base stations and then transmitted in various portions with appropriate coding, modulation and encryption to add constructively, as described with reference to FIG. 2 at the mobile device 106x.

Of course, improved signal transmission at both the mobile device and base station may be required to effect transmission over greater distances. This may, for example, be achieved using higher signal power at both the mobile device 106x and the base stations 104 and/or improved coding, modulation and encryption techniques.

Optionally, wireless device 106x (or any other mobile device 106) may include an interface to receive data over another network, as illustrated in FIG. 4. For example, wireless device 106x may include a network interface for receipt of data over a wired line connection, or the like. Again, a portion of the data received may be received over the wireless network 100, as detailed above. The remainder of the data may be received over the additional network. The data may be split so that the total data received at the device 106x may be a combination of the data received over the wireless network and the wired network. Device 106x may re-combine the data from the multiple networks, in known ways. As will be appreciated, this facilitates larger data transfer at faster speeds with greater security.

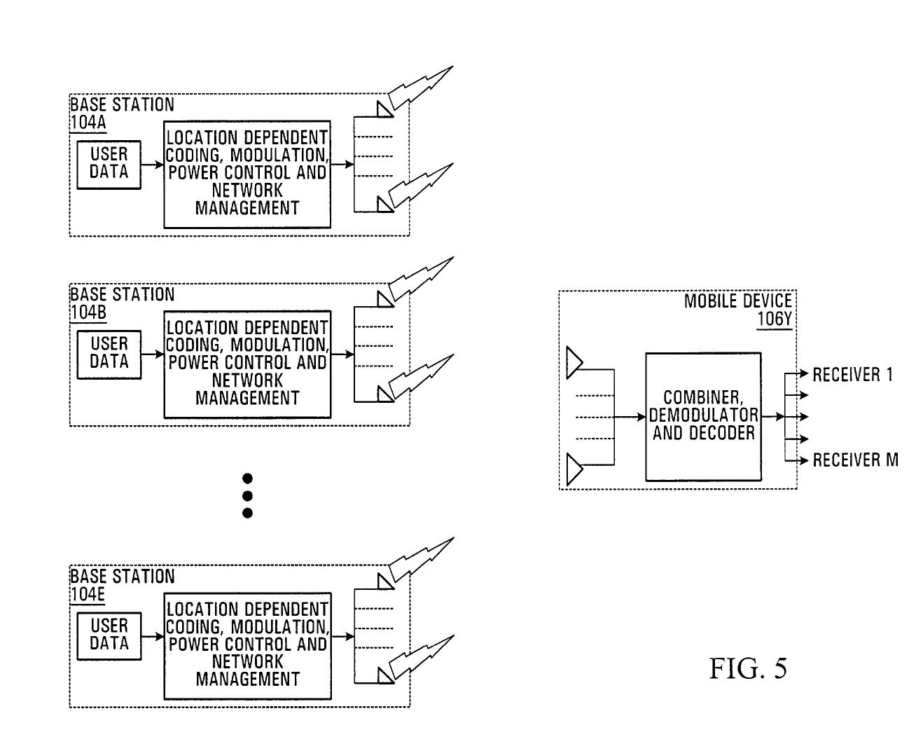

FIG. 5 similarly schematically illustrates transmission of multiple signals from a base station for combination at a mobile device 106y. Mobile device 106y may be an access node for other mobile or fixed devices and hence would act as a local wireless transmitter for the mobile devices within its range.

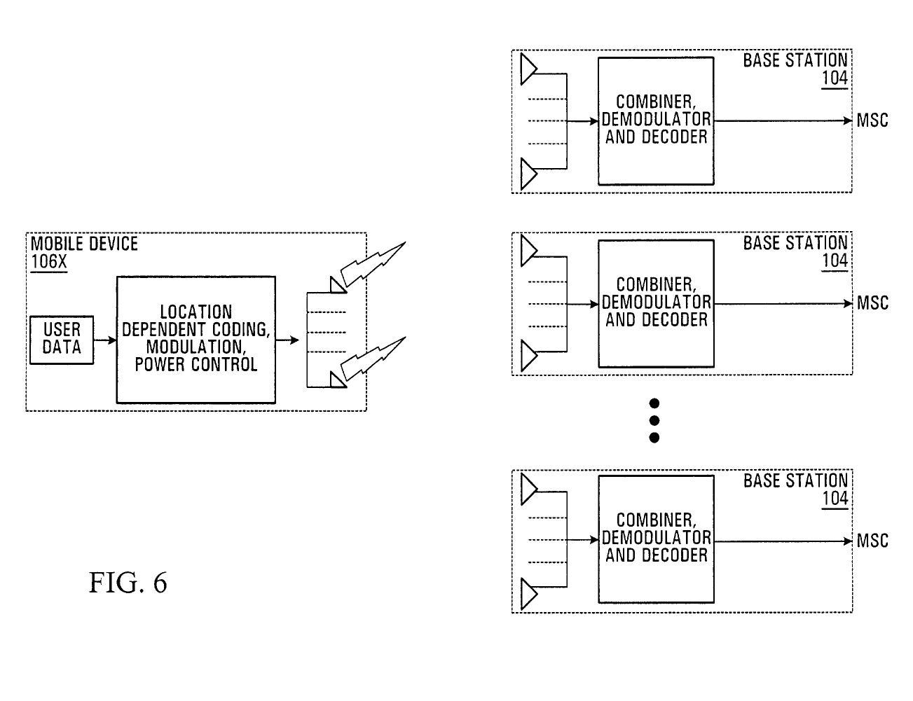

FIG. 6 illustrates transmission from mobile device 106x to multiple base stations 104 on a reverse (up) link. As on the forward (down) link, the data on the reverse (up) link could be split and transmitted to multiple base stations after appropriate coding, modulation and encryption. Specifically, the data from the mobile device could be split into multiple portions, in any number of known ways. Each portion could be transmitted over a different channel for receipt by a different base station. Co-operating base stations may recombine the received signals. This could be used to increase available bandwidth on the reverse link while reducing throughput time and increasing data security, in much the same way as communication from multiple base stations can improve communication on the downlink.

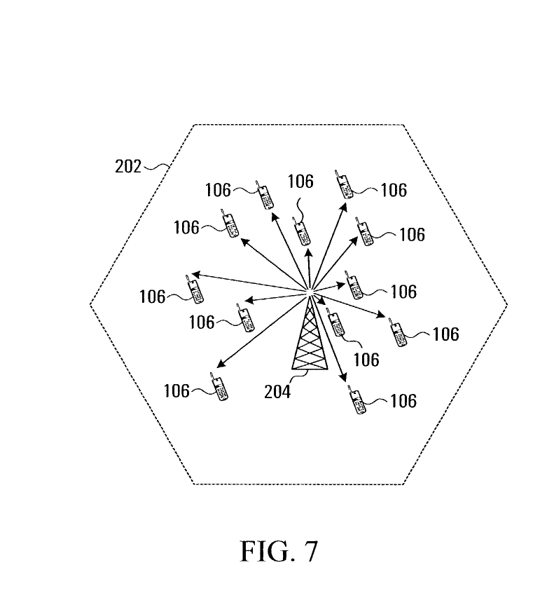

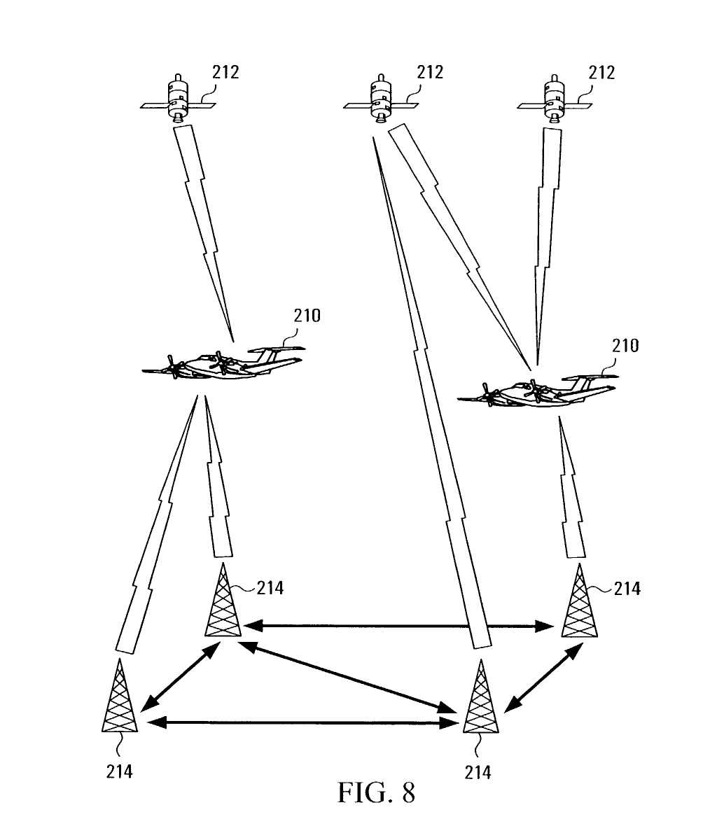

The flexibility of network 100 may further be enhanced through use of directional transmitters at base stations 104. To illustrate this, FIG. 7 illustrates a single cell 202 and a base station 204 situate in this cell, exemplary of an embodiment of the present invention. Base station 204 includes one or more directional elements, each of which geographically directs RF signals transmitted by that element using conventional multiplexing techniques for receipt by mobile devices 106. Base station 204 may have a similar architecture to base station 104, as detailed with reference to FIG. 4. In base station 204 an antenna (like transmission element 114) may be replace with a directional element. As well such a base station may include several transmitters, each in communication with a separate directional element, for transmission of data by that directional element. One or more controllers may control the direction of transmission of each directional element.

Directional elements forming part of base station 204 may be formed using omnidirectional, sectored, multi-beam, adaptive array antennas, or any other suitable directional element known to those of ordinary skill in the art. Directionality may be achieved through antenna design characteristics or through constructive and destructive spatial interference as in antenna arrays. Preferably, transmission element 114 may, for example, be a narrow dispersion thin bean antenna arrays as detailed in Advances in adaptive antenna technologies in Japan' Ogawa, Ohgane: IEICE Transaction on Communications, Vol.E84-B, No.7, July 2001.

As will be appreciated, unlike transmitters in conventional base stations (such as base station 14—FIG. 1), transmitters having directional elements can transmit RF signals in a localized region or section of a conventional cell. Effectively, use of directional elements divides each cell into multiple directional regions each of which is isolated from the others. As such, each directional region may independently use the allocated portion of the RF spectrum and the same network resources (i.e. frequencies, coding schemes, etc.).

Conveniently, base station 204 may include multiple transmitters each having its own directional element. Mobile devices 106 in different regions of the cell may, in turn, be in communication with one of the multiple transmitters of base station 204 and use the same channel resources as mobile devices in other regions, in communication with another transmitter of base station 204. Alternatively, a single directional element may be controlled to be re-oriented in time, and transmit independent signals to communicate with multiple mobile devices 204 over assigned channels.

The downlink capacity of base station 204 is therefore effectively increased by the number of directional regions within the cell. Physical channel resources may be used with reduced likelihood of interference with signals emanating with other direction elements. This leads to increased allocable channel resources, and thus increased capacity of base station 204 within cell 202.

Once the location of a mobile device of interest within cell 202 is known, base station 204 assigns a directional element and a multiplexed channel for communication with the mobile device. The directional element is controlled in dependence of the location of the mobile device to narrowcast the assigned channel in the direction of the mobile device, preferably with limited angular dispersion. Preferably, the directional element is predictively controlled using a present indicator of the mobile device 106, and past indicators of location for that device. Signals for the mobile device are thus limited within a single directional region. As the mobile device moves within the cell, the base station may track the mobile device's location within the cell. The direction of transmission of one or more directional elements may follow the movement of the mobile device, based on current and past locations of the mobile device. Optionally, as the device moves within the cell, communication with the device may be handed off between multiple directional elements. If the mobile device moves into a directional region where use of the assigned channel would interfere with a channel used by another mobile device, communication with the mobile device may be handed-off to another channel at base station 204, to avoid interference. Again, location information of multiple mobile devices known to base station 204 may be used to predict and control handoff.

Conveniently, with the increased capacity within cell 202, multiple conventional channels may be assigned to a single mobile station.

Mobile devices, such as mobile device 106y (FIG. 6) may optionally include directional transmitters. Transmission of the directional elements may be controlled in dependence on the base station to which data is to be transferred. In this way, transmissions to multiple base stations need not geographically interfere. Similarly, as the geographic space used by such a transmission is limited, interference with other communications on network 100 would be similarly limited.

As should now be readily appreciated base stations 104 (FIG. 2) could easily be modified to include direction transmission elements. Again, base stations 104 so modified could use directional elements to transmit within convention cells or across cells. In this way multiple base stations could communicate with a single mobile base station, each using direction transmitters further controlled in dependence on the location of the base station.

Advantageously, use of directional elements in base stations 104 further reduces the likelihood that wireless signals intended for one device will be received by another device that may be using the same wireless channel. Moreover, use of directional elements further reduces overall RF interference and cross-talk that may be caused by multiple base stations transmitting to a single device across conventional cell boundaries.

Base stations 104, so modified may additionally still control one or more of modulation, coding, power level, encryption, or the like in dependence on mobile station location as previously described. Conveniently, each of these may be controlled independently at each transmitter of each base station 104.

As should be appreciated, as base stations 104 transmit across conventional cell boundaries, the concept of cell within network 100 begins to lose significance. Ideally, a mobile device is serviced by those base stations having sufficient resources for doing so, and being in sufficient geographic proximity. Controlled power levels and directional elements ensure that interference of signals from multiple base stations is limited. This, in turns, allows efficient re-use of physical channels between different spaced base stations and mobile devices.

As should now also be appreciated, since the methods exemplary of the present invention may reduce channel interference and improve the signal quality at the receiver, the present invention may be embodied in or across a multitude of wireless environments. Hence, methods exemplary of the present invention may be incorporated in both present and future systems including GSM, IS-95, GPRS, EDGE, 3G systems like WCDMA, CDMA2000, and others. Similarly, such wireless environments need not be cellular. For example, the present invention could be embodied in a wireless local area network. Transmission from wireless access points or routers could be controlled in dependence on the location of local area network receivers (e.g. wireless network interface cards). Aspects of the invention could similarly be embodied in point-to-point wireless radio systems; satellite networks and the like. Similarly, the invention may be combined with fixed line devices to enhance the overall system capabilities.

As another example, predictive call hand-off between base station could take place across multiple networks. Call hand-off could, for example, be predictively set-up to allow handoff from a cellular to a WLAN network. This could thus provide seamless data transfer across multiple networks by reducing the setup time involved in allocating channel resources to the mobile device in the network that it is entering.

As further example, methods and devices exemplary of embodiments of the present invention may be used to communicate with an aircraft 210, as illustrated in FIG. 7. As illustrated, signals may be exchanged between an aircraft 210 and multiple base stations 212 and 214, each including one or more directional elements and functionally similar to base stations 104 detailed above. Aircraft 210 may include mobile receivers capable of receiving signals from base stations 212 and 214, or may be carrying passengers carrying such mobile devices. Base stations 212 and 214 may take the form of terrestrial base stations, satellites and others. As such, broadband communication between aircraft 210 in the sky and terrestrial base stations and/or satellites, in manners exemplary of embodiments of the invention is possible. Thus passengers can be provided facilities like high-speed internet access, fax and voice communications to places on the ground and even to other aircraft.

In another embodiment, base stations exemplary of embodiments of the present invention may take the form of satellites. Multiple satellites may communicate with a mobile device to enhance its data capabilities. Each satellite may allocate one or more data channels to the mobile station for data transfer. In another embodiment, the invention may be used in a local area network to enhance data capabilities. Alternative embodiments of the invention may include any other system that has some form of wireless data exchange either solely or in conjunction with other wired or wireless methods.

In yet another embodiment of the invention, mobile stations may be provided with bandwidth-on-demand. Thus, a mobile device may be allocated higher bandwidth automatically if applications at the mobile device so require. Alternatively, a user at the mobile device may request greater bandwidth or there may be some other method whereby a larger bandwidth is allotted. As required, the mobile device may be allocated one or more data channels from either one or more base stations in order to enhance his data transfer rate. This allocation of resources will depend on the mobile device's location and the availability of channels and other network resources at the base stations, among other factors.

Advantageously, method and devices exemplary of the present invention can easily be used in existing future systems, as they provide gains at the physical layer level of basic signal transmission. Deployment requires little additional hardware and software upgrades.

Additionally, although the invention has been described in the context of communications between one or more mobile devices and base stations, it will be appreciated that aspects of the invention could easily be used for peer-to-peer wireless communications between mobile devices. Each mobile device could be adapted to control transmission to another recipient device in dependence on knowledge about the recipient device's location, as detailed above.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A method of operating a base station in a cellular communications network, said base station comprising at least one directional transmission element, said method comprising:
receiving an indication of a location of a mobile device in communication with said base station over said communications network;
predictively controlling said directional transmission element to direct transmission from said base station to said mobile device based on said indication, and past indications of location of said mobile device received from said mobile device.

2. The method of claim 1, wherein said directional transmission element comprises a narrow dispersion directional element.

3. A method of communication with a mobile device comprising:
at each of a plurality of base stations in wireless communications with said mobile device, receiving an indication of a location of said mobile device over said wireless communications network;
transmitting from several of said plurality of base stations to said mobile device based on said location.

4. The method of claim 3, wherein said transmitting comprises transmitting data at a first rate, and said method further comprises receiving data from said mobile device at a second aggregate rate, said second aggregate rate different rate from said first rate.

5. The method of claim 4, wherein said first data rate is selected in dependence on bandwidth required by said mobile device.

6. The method of claim 3, wherein said transmitting comprises:
transmitting from said several base stations over distinct channels, wherein each of said distinct channels contributes to an overall bandwidth of communications between said mobile device and said base stations.

7. The method of claim 6, wherein the number of said plurality of base stations transmitting to said mobile device depends on a desired bandwidth of communication between said mobile device and said base stations.

8. The method of claim 7, wherein said signals from said several base stations are transmit on the same channel.

9. The method of claim 3, wherein said transmitting comprises:
transmitting signals from said several base stations that constructively interfere at said mobile device to increase a signal to noise ratio at said mobile device.

10. The method of claim 3, wherein said transmitting comprises:
transmitting signals from said several base stations that may be combined to reduce errors in data from said several base stations, received at said mobile device.

11. The method of claim 3, wherein a data message is split into several portions and wherein said transmitting comprises:
transmitting one of said portions of said data message from each of said several base stations, so that said data message may be completely received at said mobile device from said several base stations.

12. The method of claim 11, wherein at least one of said portions is encrypted prior to said transmitting.

13. The method of claim 3, wherein at least some of said base stations is situated on a satellite.

14. The method of claim 11, wherein at least some of said base stations are terrestrial.

15. The method of claim 11, wherein said mobile device is located on an aircraft.

16. The method of claim 3, wherein said base station comprises a wireless access point within a local area network.

17. The method of claim 3, wherein said indication reflects a location of said mobile device determined using global positioning satellites.

18. The method of claim 3, wherein said indication is determined by a user of said device and conveyed to said several of said plurality of base stations.

19. The method of claim 3, wherein said indication is derived from received signal strength indicators at said mobile device reflecting a strength of the received signal from at least some of said plurality of base stations.

20. The method of claims 3, further comprising communicating with said mobile device over a wired network.

21. A base station for use in a wireless communication network, comprising
an interface to receive an indication of a location of a mobile device;
a transmitter;
a controller in communication with said transmitter operable to control transmission of said transmitter to control one or more of a direction, coding, modulation, encryption of transmission of said data in dependence on said indication.

22. The base station of claim 21, comprising a plurality of transmitters, each comprising a directional element, each to independently transmit data to a mobile device, wherein said controller is in communication with each of said plurality of transmitters to control directional transmission therof in dependence on a position of a mobile device.

23. The base station of claim 21, wherein said controller controls directional transmission of said directional element to transmit independent signals to a plurality of mobile devices.

24. A mobile communications device comprising:
a plurality of receivers, each for receiving one of a plurality of signals from a different base station in a wireless network;
a data combiner in communication with said receivers, for combining said plurality of signals.

25. The mobile device of claim 24, further comprising a signal position receiver for receipt of signals used to determine a location of said mobile device, and a transmitter operable to transmit an indication of said location to a base station.

26. The mobile device of claim 24, wherein said signal position receiver comprises a GPS receiver.

27. The mobile device of claim 24, further comprising a plurality of transmitters for wirelessly transmitting data to a plurality of base stations.

28. The mobile device of claim 27, further comprising at least one directional element coupled to said transmitters for transmission of data to selected base station in dependence on a location of said mobile device.

29. The mobile device of claim 24, further comprising a wireless transmitter adapting said mobile device to act as a gateway to transmit data to other devices in communication with said mobile device.

30. The mobile device of claim 24, wherein said device is a fixed wireless device.

31. A method of operating a base station in a wireless network, comprising:
receiving an indication of a location of a mobile device in communication with said base station over said communications network;
transmitting data from said base station to said mobile device based on said location, by controlling one or more of a power level, direction, and coding of transmission of said data in dependence on said indication.

32. A wireless communications network comprising:
a plurality of wireless base stations in communication with each other and with a mobile device, each of said wireless base stations comprising an interface to receive an indicator of a location of said mobile device on said network, and a transmitter operable to transmit data to said mobile device in a manner dependant on said location.

33. The network of claim 32, wherein each transmitter comprises a data coder operable to code said data in dependence on said location.

34. The network of claim 32, wherein each of said transmitters is operable to transmit at a power controlled in dependence on said location.

35. The network of claim 32, wherein each of said transmitters is operable to transmit a portion of transmitted data to be received at said mobile device, said portions to be recombined at said mobile device to reconstruct said transmitted data.

36. The network of claim 35, wherein at least one of said transmitters is operable to encrypt said portion of said signal transmitted by said at least one transmitter.

37. The network of claim 32, wherein each transmitter comprises a modulator operable to modulate signals for said mobile device, in dependence on said location.

38. The network of claim 32, wherein each of said base stations comprises a directional transmission element in communication with its transmitter, and operable to transmit in dependence on said location.

39. A method of operating a base station in a wireless network, comprising:
receiving an indication of a location of a mobile device in communication with said base station over said communications network;
choosing an available transmission channel to transmit data to said mobile device, based on said location, so as to minimize interference with communications to other mobile devices;
transmitting data from said base station to said mobile device based over said chosen channel.

40. A method of operating a wireless network, in which a mobile device is in communication with a proximate base station comprising:
receiving indicators of a location of a mobile device on said network;
predictively coordinating hand-offs between base stations in dependence on said indicators.

41. The method of claim 40, wherein said predictively coordinating comprises reserving channel resources at a base station before said device is in communication with said base station to transfer data therewith.

42. A method of operating base stations on first and second of wireless networks, comprising:
receiving indicators of a location of a mobile device on said first and second network;
predictively coordinating hand-offs between base stations on said two networks in dependence on said indicators, as said mobile device moves from a location in proximity with a base station on said first network into proximity with said a base station on said second network, allowing communication with said mobile device to be handed-off from said first network to said second network.

43. A method of operating a mobile device capable of wireless transmission, comprising:
receiving an indication of a location of a recipient device in wireless communication with said mobile device;
transmitting data from said mobile device to said recipient device based on said location, by controlling one or more of a power level, direction, and coding of transmission of said data in dependence on said indication.

44. A switching center in a mobile communications network, in communication with a plurality of base stations within said network, and operable to control concurrent transmission of data from said plurality of base stations to a particular mobile device in dependence on a location of said particular mobile device.
